(19) United States
(12) Patent Application Publication
(10) Pub. No.: US 2006/0037792 A1
(43) Pub. Date: Feb. 23, 2006

(54) Vehicle equipped with individual electric wheel drive trains

(76) Inventors: Ralf Boss, Kressbronn (DE); Johannes Sorg, Ravensburg (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/529,994

(22) PCT Filed: Oct. 11, 2003
(86) PCT No.: PCT/EP03/11279

§ 371 Date: Mar. 31, 2005

(30) Foreign Application Priority Data
Oct. 16, 2002 (DE) 102 48 173.3

(51) Int. Cl. B60K 1/00

(52) U.S. Cl. 180/65.6

(57) ABSTRACT

In a vehicle equipped with individual, electric wheel, drive trains, prime movers (16, 18) are situated radially outside the drive wheels (4, 6) and by a linking transmission (12, 14) rigidly connected with a vehicle body (2) are operatively coupled with drive wheels (4, 6). The drive wheels (4, 6) are unsprung relative to the vehicle body (2) and connected by transmission shafts (8, 10) with the linking transmission (12, 14). One shiftable clutch (32) is proposed with which the two drive wheels (4, 6) can be selectively operatively coupled together.

The invention concerns a vehicle equipped with individual electric wheel drive trains, particularly a multi-axle driven off-road vehicle, having one body and at least one left and one right drive wheel with each coordinating one power train having at least one electric prime mover wherein the prime mover is situated at least partly radially outside the drive wheel in the axial installation space occupied by the drive wheel. One left linking transmission is provided for operative connection of one left prime mover with the left drive wheel and one right linking transmission is provided for operative connection of one right prime mover with the right drive wheel, which is located upon the side of the drive wheel and the prime mover facing the center of the vehicle and the housing of which is rigidly connected with the vehicle body. One transmission shaft is provided between the output of the linking transmission and the drive wheel which, via one joint, is connected with the output of the linking transmission.

One such transmission is known from the Applicant's unpublished German Patent application 102 25 731. It stands out by an arrangement very favorable to installation space of the electric prime movers and by small unsprung masses of the flexibly suspended drive wheels.

The failure of a prime mover in case of an unfavorable position of the vehicle on the ground can, of course, result in that the vehicle cannot be subsequently moved. Extreme driving conditions can actually occur in which sufficient traction can no longer be produced just by the other drive wheels; the prime movers of which still function. In case of irregular traction ratios or of steeply inclined driving routes, beyond that situation can appear in, which for a long period of time, one drive wheel of one axle transmits substantially more power than the other. In this case, the installed electric input power cannot be fully transmitted to the drive wheels.

DE 44 34 237 A1 discloses a vehicle axle for agricultural vehicles having individual wheel drive trains where one clutch is provided by which the individual wheel drive trains of one axle can be interconnected with positive engagement. In this vehicle axle, the prime movers, transmission and drive wheels of the left and right sides are unsprung interconnected. The unsprung masses of the vehicle axle are very large, therefore, it is not suited for high speed, off-road vehicles. Moreover, the arrangement of the electric prime movers in the installation space between the two drive wheels is unfavorable when the installation space is to be utilized in a different way.

The problem on which the invention is based is to develop a vehicle equipped with individual, electrical wheel, drive trains of the type mentioned above such that, even in case of failure of one prime mover, the vehicle remains off-road and in which the prime movers are uniformly loaded. It should be adequate for high speeds off-road and the installation space between the drive wheels of a drive axle should not be needed by the electric prime movers.

Said problem is solved with a vehicle having the features of the main claim. Advantageous developments of the invention are given in the sub-claims.

A shiftable clutch is, according to the invention, with a left and a right wheel standing opposite each other and can selectively be operatively coupled with each other. In the normal operation of the vehicle, a left and a right drive wheels of a drive axle are driven independently of each other so that differences in rotational speed are possible when cornering. In certain driving situations, however, it is possible to couple the left and the right drive wheels with each other, via the shiftable clutch. In one case in which this proves advantageous is when one of the prime movers fails. When the clutch is closed, the input torque of the operating motor is divided between both wheels. The traction is improved and no interruptions result of the straight line outflow. In a second case, it is advantageous to close the clutch when one of the two drive wheels of one driven axle has no traction. When the clutch is closed, it is possible to transmit the drive power of both prime movers to the wheel which still has traction. In a driving situation in which one prime mover fails and the drive wheel coordinated with the other prime mover has no traction, the closing of the clutch is also advantageous. In this way, the functioning prime mover can be connected with the drive wheel which has traction ensuring the advancement of the vehicle.

In one advantageous development of the invention, the left linking transmission and the right linking transmission have a common housing where additionally is located the shiftable clutch. The transmission housing is preferably situated in the area of the vehicle center so that sufficiently long transmission shafts can be situated between the housing and the left and the right drive wheels, which allow a large engagement path.

Should the area of the vehicle's center remain free of driving components, it is, likewise, possible to provide a separate transmission housing for the left linking transmission and the right linking transmission, respectively. In one advantageous development of this design, the shiftable clutch is situated in or on one of the separate transmission housing so that only one shaft passes between the two linking transmissions in the area of the vehicle's center.

The shiftable clutch is situated between two matching transmission elements of the linking transmission and of the right linking transmission. As a rule the rotational speeds of the electric prime movers are higher than the rotational speeds of the driven wheels. The maximum torque to be transmitted by the clutch is not greater than the motor torque of an electric prime mover, when the shiftable clutch is situated between a transmission element of the left linking transmission non-rotatably connected with the left prime mover and a transmission element of the right linking transmission non-rotatably connected with the right prime mover.

For reasons of installation space, however, it can be advantageous to situate the shiftable clutch between a transmission element of the left linking transmission non-rotatably connected with the left drive wheel and a transmission element of the right linking transmission non-rotatably connected with the right drive wheel. Finally, the shiftable clutch can also be placed between matching intermediate wheels of the left and right linking transmissions.

The invention is explained in detail with reference to the enclosed Figures which diagrammatically show different embodiments of drive axles having individual electric wheel drive trains.

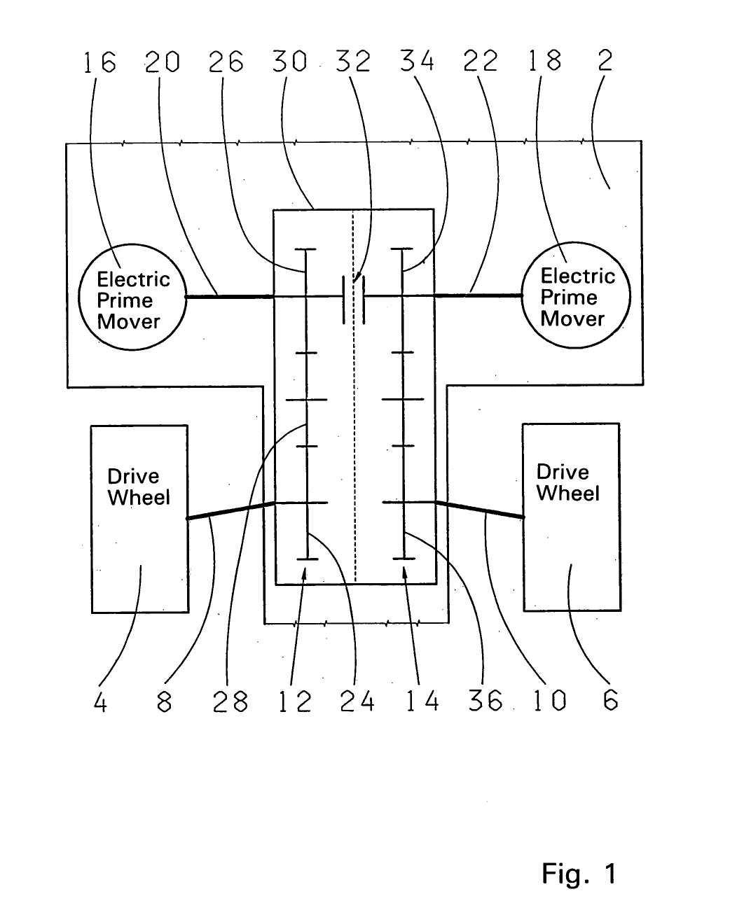

In FIG. 1, one section of a vehicle body of a multi-axle driven off-road vehicle is designated with 2. A left drive wheel 4 and the right drive wheel 6 of one drive axle are flexibly connected via transmission shafts 8, 10 with the outputs of a left linking transmission 12 and of a right linking transmission 14, both being designed as spur gear chain. A left prime mover 16 and a right prime mover 18 are radially disposed outside the drive wheels 4, 6 and at least partly occupy the same axial installation space as the drive wheels 4, 6 coordinated therewith. This arrangement is the object of the Applicant's German patent application 102 25 731. It is made clear that the disclosure contents of the instant application comprise the contents of the earlier patent application. The entrances of the left linking transmission 12 and the right linking transmission 14 are in constant operative connection with motor shafts 20, 22 of the two electric prime movers 16, 18. Between a spur gear 24 on the output side and a spur gear 26 on the input side in the two linking transmissions 12, 14, one intermediate wheel 28 is located which forms a spur gear chain with the spur gears 24, 26. Both linking transmissions 12, 14 have a common transmission housing 30 where a shiftable clutch 32 is also situated. The two linking transmissions 12, 14 with their housing 30 are rigidly connected with the vehicle body 2 while the drive wheels 4, 6 are flexibly suspended. The unsprung masses of the drive wheels are very small so that even at high speeds off-road, good driving qualities are ensured and the shock absorbers undergo only relatively light thermal loads.

The shiftable clutch 32 can be designed, for example, as a hydraulic multi-disc clutch, asa synchronized or an unsynchronized dog clutch. It makes selectively coupling the left and right individual wheel drive trains possible. It performs the function of shiftable differential lock. When the clutch is closed it is further ensured that the input power transmissible by the drive wheels 4, 6 is uniformly distributed upon the two prime movers. If one prime mover 16, 18 fails, then the drive wheel 4, 6 coordinated with said prime mover can still be driven by the operating prime mover.

In the embodiment according to FIG. 1, the shiftable clutch 32 is situated between two spur gears 26, 34 of which each is non-rotatably connected with the two prime movers 16, 18.

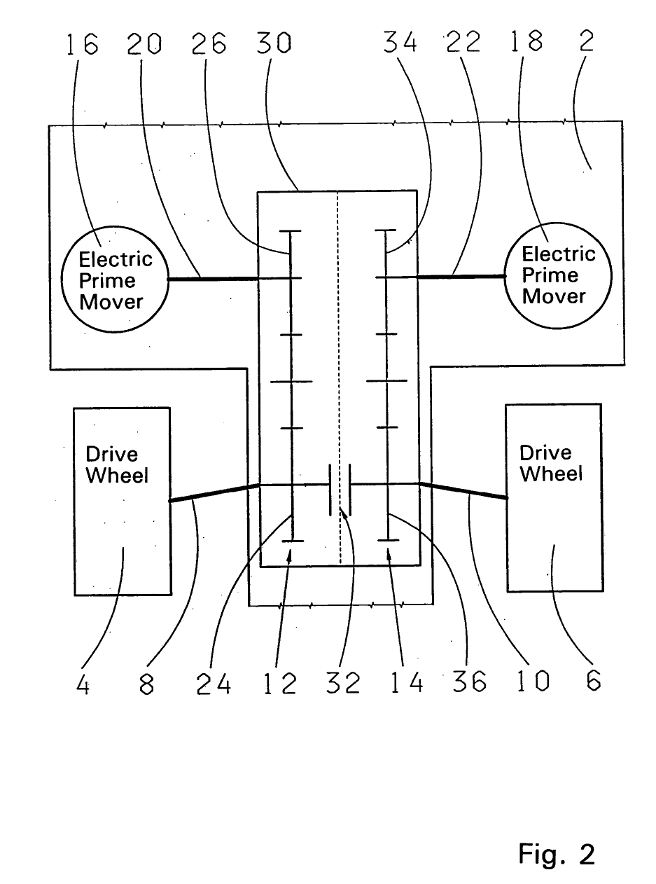

In FIG. 2 the same positions are provided with corresponding reference numerals as in FIG. 1. Unlike the embodiment of FIG. 1, the shiftable clutch 32 is disposed between the spur gear 24 of the left linking transmission 12 non-rotatably connected with the left drive wheel 4 and a spur gear 36 of the right linking transmission 14 non-rotatably connected with the right drive wheel 6.

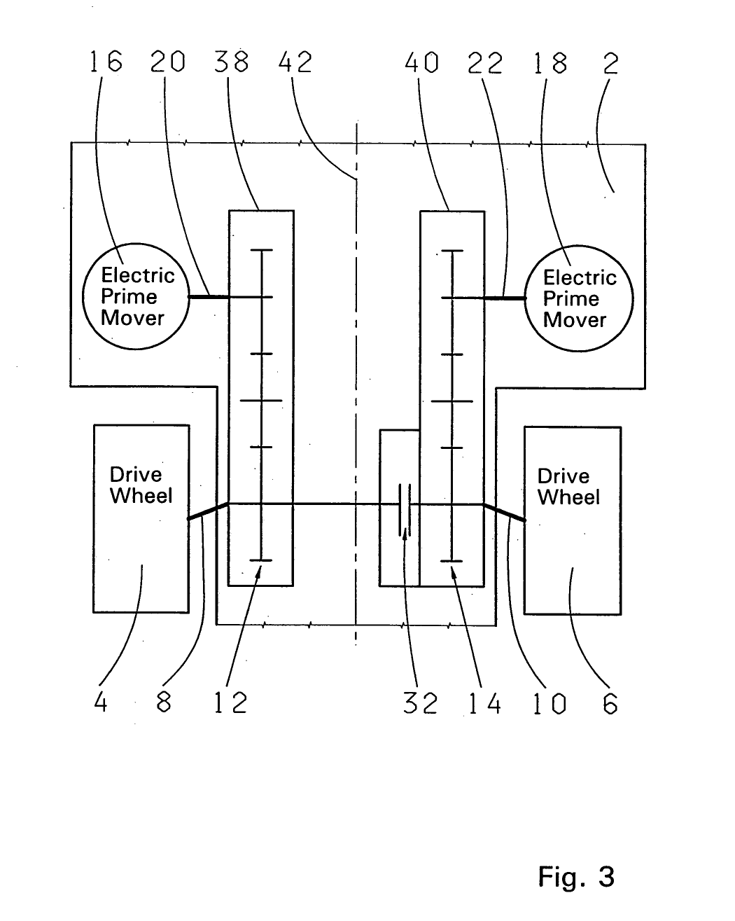

In the embodiment according to FIG. 3, the left linking transmission 12 has one housing 38 and the right linking transmission 14 one separate housing 40. The installation space along a central line 42 of the vehicle, therefore, remains to a great extent free of driving components whereby, for example, a lower floor is made possible in a passenger compartment of the off-road vehicle. The shiftable clutch 32 is located in the housing 40 of the right linking transmission 14.

### REFERENCE NUMERALS

2 vehicle body
4 drive wheel
6 drive wheel
8 transmission shaft
10 transmission shaft
12 linking transmission
14 linking transmission
16 electric prime mover
18 electric prime mover
20 motor shaft
22 motor shaft
24 spur gear
26 spur gear
28 intermediate wheel
30 transmission housing
32 clutch
34 spur gear
36 spur gear
38 transmission housing
40 transmission housing
42 central line

1-7. (canceled)

8. A vehicle equipped with individual electric wheel drive trains, particularly multi-axle driven off-road vehicles, comprising one vehicle body (2) and at least one left and one right drive wheels (4, 6) each of which is coordinated with one drive train having at least one electric prime mover (16, 18), said prime mover (16, 18) being situated radially outside the drive wheel (4, 6) at least partly in the installation space occupied by the drive wheel (4, 6), one left linking transmission (12) being provided for operative connection of a left prime mover (16) with the left drive wheel (4) and for operative connection of a right prime mover (18) with the right drive wheel (6), one right linking transmission (14) is situated upon the side of drive wheel (4, 6) and the prime mover (16, 18) facing a vehicle center (42) and a housing (30) of which is rigidly connected with the vehicle body (2), there being provided between an output of each of the left and the right linking transmission (12, 14) and the left and the right drive wheels (4, 6), transmission shafts (8, 10) which by means of a joint are connected with the output of the connecting transmission (12, 14) and one shiftable clutch (32) is provided with which the left drive wheel (4) and the opposite right drive wheel (6) can selectively be operatively coupled together.

9. The vehicle according to claim 8, wherein the left linking transmission (12) and the right linking transmission (14) have a common housing (30) where the shiftable clutch (32) is located.

10. The vehicle according to claim 8, wherein the left linking transmission (12) and the right linking transmission (14) each have one separate housing.

11. The vehicle according to claim 10, wherein the shiftable clutch (32) is situated in only one of the separate transmission housings.

12. The vehicle according to claim 8, wherein the shiftable clutch (32) is situated between a first transmission element (26) of the left linking transmission (12) non-rotatably connected with the prime mover (16) and a second transmission element (34) of the right linking transmission (14) non-rotatably connected with the right prime mover (18).

13. The vehicle according to claim 8, wherein the shiftable clutch (32) is situated between a first transmission element (24) of the left linking transmission (12) non-rotatably connected with the left drive wheel (4) and a second transmission element (36) of the right liking transmission 914) non-rotatably connected with the right drive wheel (6).

14. The vehicle according to claim 8, wherein the shiftable clutch is situated between an intermediate wheel (28) of the left linking transmission (12) and an intermediate wheel of the right linking transmission (14).
